(19) United States
(12) Patent Application Publication
(10) Pub. No.: US 2002/0199205 A1
(43) Pub. Date: Dec. 26, 2002

(54) Method and apparatus for delivering consumer entertainment services using virtual devices accessed over a high-speed quality-of-service-enabled communications network

(75) Inventors: Nitin Sonawane, Nashua, NH (US); Vikram Saksena, Acton, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Narad Networks, Inc, Westford, MA (US)

(21) Appl. No.: 10/180,950

(22) Filed: Jun. 25, 2002

Related U.S. Application Data
(60) Provisional application No. 60/300,628, filed on Jun. 25, 2001.

(51) Int. Cl. H04N 7/173; H04N 7/16; H04L 12/28; H04L 12/56

(52) U.S. Cl. 725/115; 725/145; 725/93; 725/116; 370/395.21; 370/395.43

(57) ABSTRACT

A virtual storage adapter provides networked data storage to a data processing device for delivering consumer entertainment services using virtual devices accessed over a high-speed quality-of-service-enabled communications network. A data storage device emulation unit emulates the functionality of a data storage device (e.g., a DVD or a CD) and a network interface comprising an IP Small Computer System Interface (“iSCSI”) compatible interface connects the data storage device emulation unit to an iSCSI storage gateway. The virtual storage adapter provides video on demand (“VoD”) services using a video on demand server comprising a video on demand portal for selection and an administration unit for billing. Personal video recorder services are also provided, including data expiration, capacity on demand, consolidated recording and community recording features.

### RELATED APPLICATION

This application claims the benefit of U.S. Provisional Application No. 60/300,628, filed on Jun. 25, 2001. The entire teachings of the above application is incorporated herein by reference.

### BACKGROUND OF THE INVENTION

Consumer entertainment services, including video on demand (“VoD”) and personal video recorder (“PVR”) services can be delivered using conventional communication systems architectures. In conventional digital cable systems, a channel is dedicated to the user for the duration of the video. VoD services which attempt to emulate the display of a digital versatile/video disk (“DVD”) are delivered from centralized video servers that are large super-computer style processing machines. These machines are typically located at a metro services delivery center supported on a cable multiple service operator's (“MSO”) metropolitan area network. The consumer selects the video from a menu and the video is streamed out from a video server. The video server encodes the video on the fly and streams out the content to a set-top box that decodes it on the fly; no caching or local storage is required at the set-top box. In such a centralized video server architecture, the number of simultaneous users is constrained by the capacity of the video server. This solution can be quite expensive and difficult to scale. “Juke-box” style DVD servers suffer from similar performance and scalability problems.

IP streaming can be used to avoid dedicating channel bandwidth to each user. IP streaming has been designed to overcome the shortcomings of typical IP networks by providing codecs that are friendlier to packet loss and can tolerate multiple available bit-rates. Thus, the same video stream can continue to play, albeit at a lower quality, should the network suddenly get congested.

Personal video recorder services (e.g., TiVo and Replay TV) allow consumers to record selected programs on local storage and play them later, at their convenience. Such services are popular with consumers as they replace the sequentially-accessible and cumbersome videotapes with randomly-accessible hard drives. Such hard-disk enabled devices bring superior recording and replay capabilities, such as instant fast-forward and recording of multiple programs simultaneously.

These capabilities come at a significant price. Hard drive prices have dropped significantly; however, they are still a big portion of the total bill of materials for a personal video recorder, often 30% or more. Volume production and other logistics have kept the median price of hard drives at an optimal level for personal computers but too high for low-cost consumer devices. Hard drives have a mean time between failure (MTBF) of approximately 300,000 hours, or around thirty years. While that may seem high, this is a probabilistic value. As the number of hard drives deployed goes up, so does the frequency of failure. For example, for a customer base of 30,000 users, the service provider may be replacing about 100 hard drives every month. Therefore, from a service provider perspective, the frequency and cost of servicing customer premise equipment (CPE) goes up with the number of users. Furthermore, additional power and cooling requirements make the reliability of a hard disk enabled device significantly lower than the same device without a hard drive. Hard drives are constantly getting bigger and faster. Typical hard drive capacities are now in the 40-60 Gigabyte (GB) range. Though 40 GB may be enough for most desktop computer applications, it is inadequate for recording video. Although some PVR devices advertise “up to 60 hours of recording capability”, this is often “at the lowest recording quality”.

While consumers and service providers face the above issues, content providers face other issues, including a serious risk of piracy. Digitally recorded content can be easily shared over high-capacity networks in addition to being written to writable CDs, DVDs and other storage media. The recording industry's recent attempts to battle piracy have seen little to no success. Some analysts believe that content piracy has severely inhibited the progress of the digital content industry.

Typical DVD players operate at a minimum 8×(150 Kbps) speed, producing 8×150 Kbps×8 bits/byte=9.6 Mbps with a latency of <100 ms. DVD players require predictable throughput in a burst-mode (e.g., constant 128 KByte block fetches every 100 milliseconds).

Current video servers, (e.g., the n4 video server from nCUBE of Beaverton, Oreg.), employ large processors, or a network of large processors, to serve video content. The number of simultaneous users they can support is constrained by the capacity of the video server. Typical video servers encode their content on the fly (e.g., for Real Media or Windows Media formats) and set-top-boxes decode on the fly.

### SUMMARY OF THE INVENTION

Conventional solutions for providing consumer entertainment services suffer from problems of performance, scalability and piracy. The present invention provides a virtual storage adapter for delivering consumer entertainment services using virtual devices. The virtual devices are accessed over a high-speed quality-of-service-enabled (“QoS”) communications network.

A virtual storage adapter provides networked data storage to a data processing device for delivering consumer entertainment services using virtual devices accessed over a high-speed quality-of-service-enabled communications network. A data storage device emulation unit emulates the functionality of a data storage device (e.g., a DVD or a CD) and a network interface comprising an IP Small Computer System Interface (“iSCSI”) compatible interface connects the data storage device emulation unit to an iSCSI storage gateway on the quality of service enabled communications network. The high-speed quality-of-service-enabled communications network can be implemented over a hybrid-fiber/cable network providing at least a Constant Bit Rate Real-Time Services (CBRT-TS) level of Quality of Service. An example high-speed quality-of-service-enabled communications network providing (CBRT-TS) level of Quality of Service is the hybrid-fiber/cable network from Narad Networks, Inc. of Westford, Mass..

The virtual storage adapter can provide video on demand services using a video on demand server. The video on demand server comprises a video on demand portal providing selection of data for a specific user and a video on demand administration unit providing data billing and data access expiration management. The video on demand portal can provide a listing feature to enumerate the currently available data. The video on demand services can include an automatic data access expiration feature.

The virtual storage adapter can provide personal video recorder services using a personal video recorder server. The personal video recorder server comprises a personal video recorder administration unit which provides a data expiration feature, a capacity on demand feature, a consolidated recording feature and a community recording feature.

The present invention can support S-Video quality video and 6-channel audio with high reliability and centralized management and administration to provide a highly feature-rich content delivery platform. Piracy protection is provided by preventing data from being stored on the user's CPE. The customer perceives a virtual DVD juke-box being presented with programmed data expiration. This familiar DVD model offers a high-quality interactive experience for the user.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIGS. 1a and 1b illustrate a conventional DVD system providing local data display.

FIGS. 2a and 2b illustrate a conventional video streaming system providing remote data display.

FIG. 3 illustrates an embodiment of a high-speed quality-of-service-enabled (“QoS”) communications network

FIGS. 4a and 4b illustrate an architecture using a virtual storage adapter for providing display of networked data.

FIG. 5 is an illustration of a video on demand service provided using a virtual storage adapter.

FIG. 6 is an illustration of a personal video recorder service provided using a virtual storage adapter.

### DETAILED DESCRIPTION OF THE INVENTION

A description of preferred embodiments of the invention follows. This application is related to co-pending application Ser. No. 10/142,728, “System and Method for Network Service Provisioning”, filed May 8, 2002, and application Ser. No. 09/952,374, “Broadband System With Intelligent Network Devices”, filed Sep. 13, 2001, the entire teachings of these applications are incorporated herein by reference.

In one embodiment the present invention comprises a set top box including a virtual storage adapter. The set top box is connected to a high speed quality-of-service (QoS) enabled communications network providing access to an iSCSI gateway. Data stored on the iSCSI gateway is presented to the user of the set top box as if it were stored locally. For example, DVDs can be selected, specific tracks can be selected, screen formats, scene angles, subtitles and other options can set. Similarly, audio CDs can be selected and specific tracks can be selected. The virtual access to CDs/DVDs can be combined with a server to provide video on demand services. Virtual access to networked disk drives can be combined with a server to provide personal video recorder services.

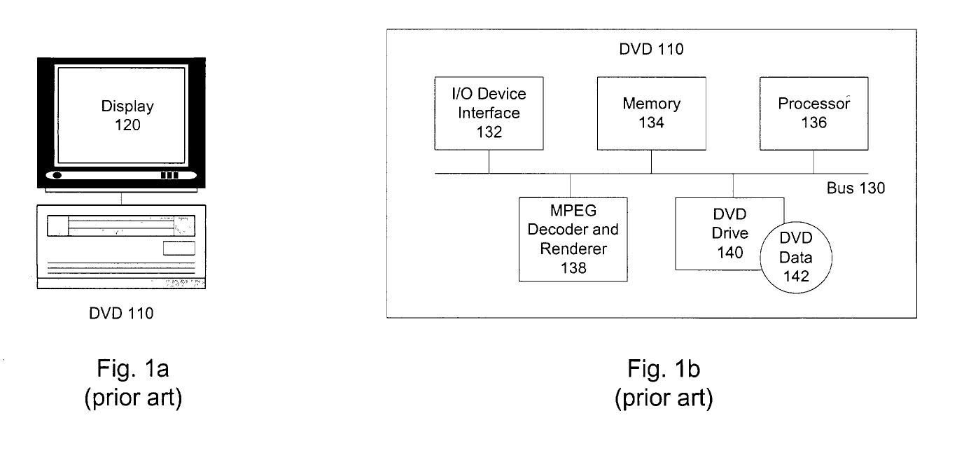

FIGS. 1a and 1b illustrate a conventional DVD system providing local data display. A DVD device 110 is attached to a display 120 to provide a displayed image of DVD data 142. The device 110 is composed of a series of units, including I/O device interface 132 for connecting I/O devices (e.g., display 120 and/or external speakers), a volatile memory 134 and a processor 136. The units are connected by a bus 130. Also connected to bus 130 is a DVD drive 140 for accepting DVD data 142 (e.g., a DVD) and an MPEG decoder and renderer for decoding the encoded DVD images. The DVD drive 140 can be configured in a “juke-box” arrangement, allowing access to multiple DVD data 142 units.

Performance, scalability and piracy problems result from the conventional DVD system. The DVD drive 140 is subject to failure and degradation as the wear and tear of playing multiple DVD data 142 takes effect. The DVD system of FIGS. 1a, 1b also does not scale well; in order for a user to choose from a large selection of DVDs they must have the full library physically available for inserting into DVD drive 140. This is not practical as the number of content titles available is constantly increasing. Additionally, with the content physically available to the user the opportunity for unauthorized copying is increased.

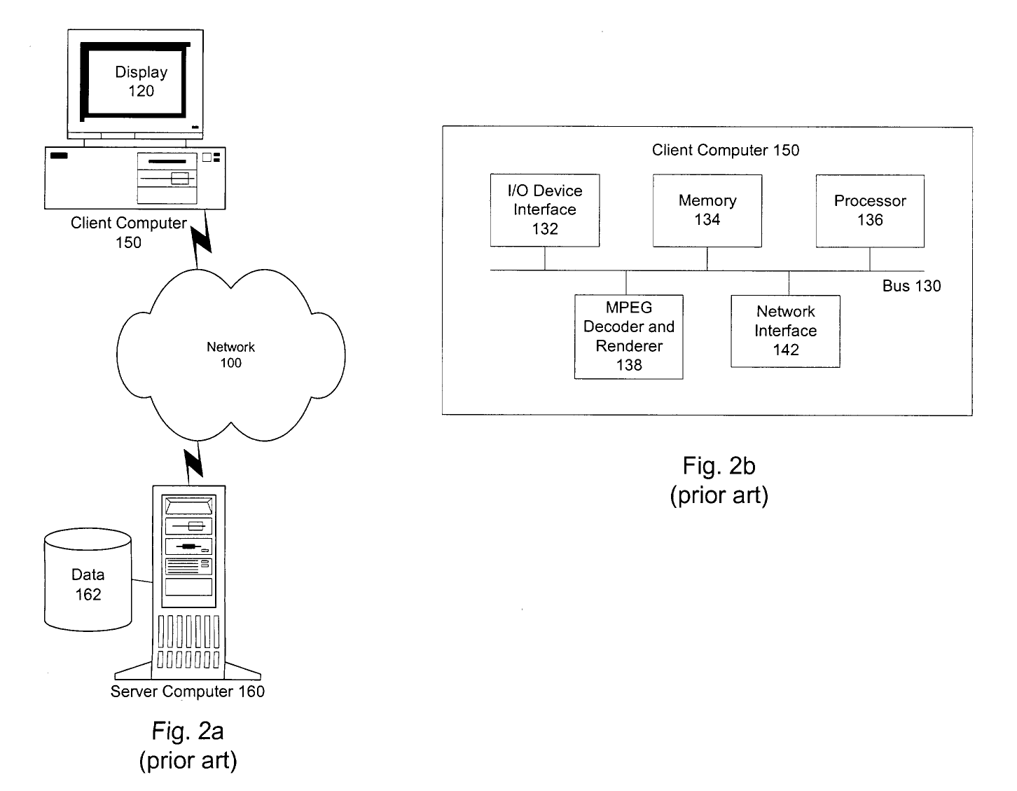

FIGS. 2a and 2b illustrate a conventional video streaming system providing remote data display. Video streaming addresses some of the problems of scalability by providing large libraries of content accessible over a communications network. Portions of the data content 162 are streamed over a communications network 100 by server computer 160 to client computer 150. The streamed portions, or packets, are then processed by client computer 160 and display to the user on display 120. Typically, communications network 100 is an IP-based network.

Client computer 150 is attached to a display 120 to provide a displayed image of streamed content data. Client computer 150 is composed of a series of units, including I/O device interface 132 for connecting I/O devices (e.g., display 120 and/or external speakers), a volatile memory 134 and a processor 136. The units are connected by a bus 130. Also connected to bus 130 is a network interface for receiving the streamed data content from the communications network 100 and an MPEG decoder and renderer for decoding the encoded streamed images.

IP streaming technology (e.g., protocols, codecs) are geared to overcome some of the inefficiencies of present-day IP networks, but any solution for delivering consumer entertainment services must provide at least DVD-quality output. Since standard IP protocols, including iSCSI, are based on TCP, they do not tolerate packet loss. Packet recovery is at the mercy of TCP sliding window timeouts. This scheme does not work for delivering consumer entertainment services on a communications network having unpredictable flow with packet loss.

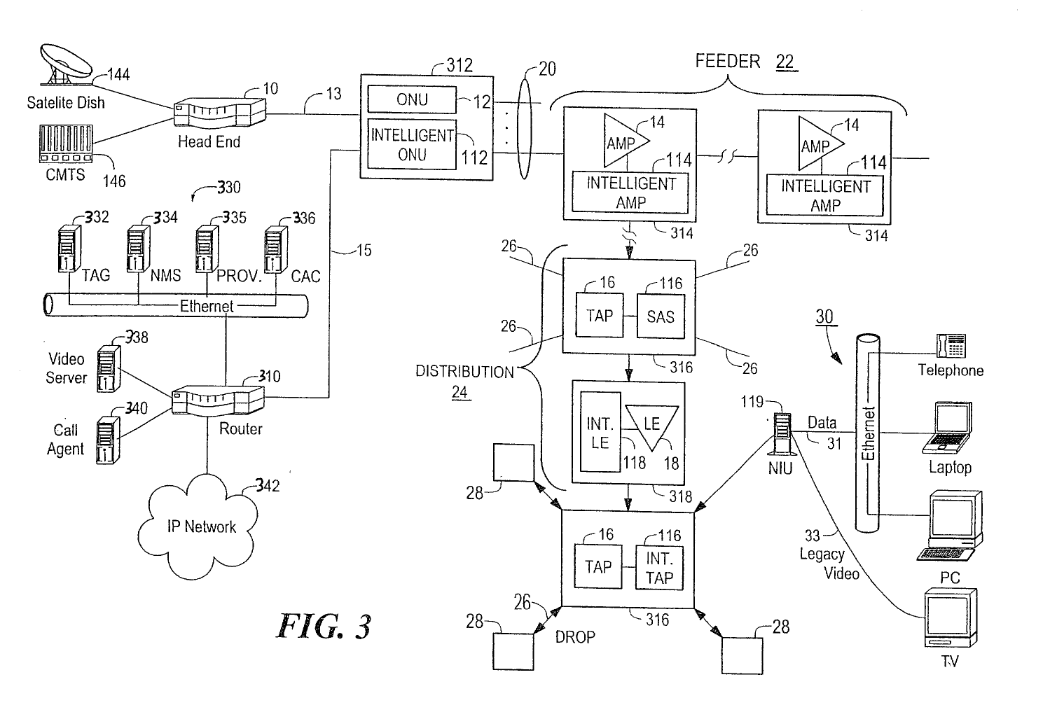

FIG. 3 illustrates an embodiment of a network configuration of intelligent network elements for providing point-to-point data links between intelligent network elements in a broadband, bidirectional access system for providing a high-speed quality-of-service-enabled (“QoS”) communications network. This network configuration is described in U.S. patent application Ser. No. 09/952,321 filed Sep. 13, 2001 entitled “Broadband System With Topology Discovery”, by Gautam Desai, et al, the entire teachings of which are incorporated herein by reference. The network configuration, also referred to herein as the Narad network, includes intelligent network elements each of which uses a physical layer technology that allows data connections to be carried over coax cable distribution facilities from every subscriber. In particular, point-to-point data links are established between the intelligent network elements over the coax cable plant. Signals are terminated at the intelligent network elements, switched and regenerated for transmission across upstream or downstream data links as needed to connect a home to the headend.

The intelligent network elements are interconnected using the existing cable television network such that the point-to-point data links are carried on the cable plant using bandwidth that resides above the standard upstream/downstream spectrum. For example, the bandwidth can reside at 1025 to 1125 MHZ (upstream) and 1300 to 1400 MHZ (downstream) or 100 Mbps upstream and downstream bandwidths can be provided in the spectrum 750 to 860 MHZ or duplexing channel spectrums can be allocated in the 777.5 MHz to 922.5 MHz regime for 100 Mb/s operation and in the 1 GHz to 2 GHz regime for 1 Gb/s operation.

The intelligent network elements include an intelligent optical network unit (“ONU”) or node 112, intelligent trunk amplifier 114, intelligent tap or subscriber access switch (“SAS”) 116, intelligent line extender 118 and network interface unit (“NIU”) 119. A standard residential gateway or local area network 30 connected to the NIU 119 at the home is also shown. Data travels through data communications line 31 and video travels through legacy video communications line 33. Note that the trunk amplifier 114 is also referred to herein as a distribution switch (“DS”). The configuration shown includes ONU assembly 312 comprising standard ONU 12 and intelligent ONU 112 also referred to herein as an optical distribution switch (“ODS”). Likewise, trunk amplifier or DA assembly 314 (Feeder 22) includes conventional trunk amp 14 and intelligent trunk amp 114; cable tap assembly 316 includes standard tap 16, and subscriber access switch 116; and line extender assembly 318 includes standard line extender 18 and intelligent line extender 118. Cable tap assemblies 316 connect to homes 28 through distribution lines 26.

The intelligent ONU or ODS is connected over line 15 to a router 310, which has connections to a server farm 330, a video server 338, a call agent 340 and IP network 342. The server farm 330 includes a Tag/Topology server 332, a network management system (“NMS”) server 334, a provisioning server 335 and a connection admission control (“CAC”) server 336, all coupled to an Ethernet bus which are described in U.S. patent application Ser. No. 09/952,321 filed Sep. 13, 2001 entitled “Broadband System With Topology Discovery”, by Gautam Desai, et al, the entire teachings of which are incorporated herein by reference.

A headend 10 is shown having connections to a satellite dish 144 and CMTS 146. To serve the legacy portion of the network, the headend 10 delivers a conventional amplitude modulated optical signal to the ONU 12 over communications line 13. This signal includes the analog video and DOCSIS channels. The ONU performs an optical to electrical (“O/E”) conversion and sends radio frequency (“RF”) signals over feeder coax cables 20 to the trunk amplifiers or DAs 14. Each DA along the path amplifies these RF signals and distributes them over the distribution portion 24.

The present system includes intelligent network elements that can provide high bandwidth capacity to each home. In the Narad network of the present invention, each intelligent network element provides switching of data packets for data flow downstream and statistical multiplexing and priority queuing for data flow upstream. The legacy video and DOCSIS data signals can flow through transparently because the intelligent network elements use a part of the frequency spectrum of the coax cable that does not overlap with the spectrum being used for legacy services.

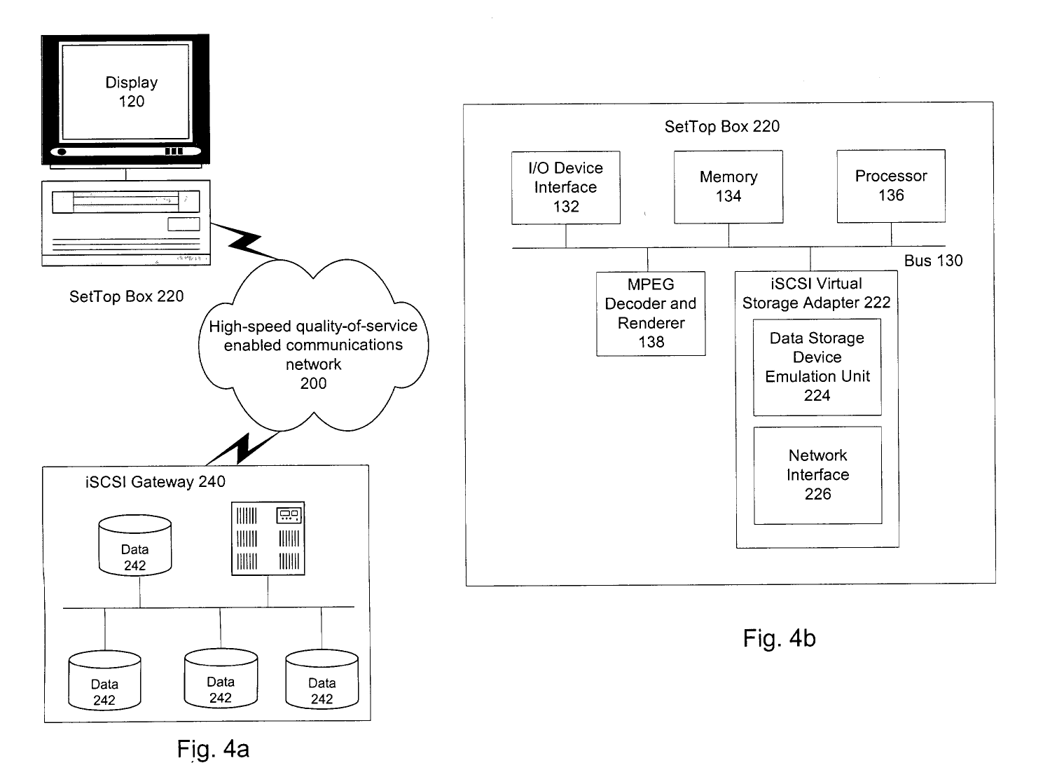

FIGS. 4a and 4b illustrate an architecture using a virtual storage adapter for providing display of networked data. The architecture includes a virtual storage adapter in a set top box, a high-speed quality-of-service-enabled communications network and iSCSI storage gateway.

A virtual storage adapter provides networked data storage to a data processing device for delivering consumer entertainment services using virtual devices accessed over a high-speed quality-of-service-enabled communications network. A set top box 220 is connected to a display 120 and a high-speed quality-of-service-enabled communications network 200 in order to display data 242 stored on iSCSI gateway 240. The set top box 220 is composed of a series of units, including I/O device interface 132 for connecting I/O devices (e.g., display 120 and/or external speakers), a volatile memory 134, a processor 136 and an MPEG decoder and renderer for decoding the encoded streamed images. The units are connected by a bus 130. Also connected to bus 130 is an iSCSI virtual storage adapter 222.

The iSCSI virtual storage adapter 222 is composed of data storage device emulation unit 224 and network interface 226. Data storage emulation unit 224 emulates the operation of a data storage device (e.g., CD drive, DVD drive, etc) such that commands from processor 136 passed on bus 130 are responded to as if a local data storage device were present. The commands may, for example, request that a specific track be selected on a CD/DVD. The commands are converted into iSCSI commands using network interface 226 to access data 242 (e.g., the specific CD/DVD track selected) over high-speed quality-of-service-enabled communications network 200. Network interface 226 communicates using the protocols defined for high-speed quality-of-service-enabled communications network 200, thus ensuring the device access performance is comparable to that expected of a local device. The accessed data 242 is then used by data storage emulation unit 224 to respond to the command from processor 136. In this way, the set top box 220, which can be a DVD player, CD player, personal video recorder, cable access box, network access device, residential gateway or other audio/video access device, can function as if it had local storage capability (e.g., DVD, CD, hard drive, etc.).

The present invention comprises a new architecture for delivering consumer entertainment services over a high-speed quality-of-service-enabled communications network. Generally a high speed communications network uses a broadband network architecture to support high-speed (e.g., 100 Mbps/1 Gbps Ethernet) services over an existing hybrid fiber coaxial (“HFC”) infrastructure. An exemplary high-speed quality-of-service-enabled communications network 200 is described in co-pending application Ser. No. 09/952,374 and referenced herein as the Narad enabled HFC network (“Narad network”) 200 and will be used as a preferred embodiment through out this specification. The bandwidth management and multi-service quality of service (“QoS”) functionality of the Narad network 200 allows MSOs to create a storage area networking (“SAN”) capability that can be effectively leveraged for delivering a variety of consumer entertainment services. This architecture overcomes the disadvantages of present-day solutions by fully utilizing the capabilities of the Narad network 200. The Narad network 200 allows intelligent set-top boxes 220 or residential gateways embedded with Narad network technology to access data content from remote storage farms (e.g., iSCSI gateways) as simply and seamlessly as local data content. The SAN capability also eliminates the need to maintain centralized video servers, which are expensive and difficult to scale, by distributing server-based data content control functionality into set-top boxes 220 through the iSCSI virtual storage adapter 222. The Narad network 200 with bandwidth management controls allow low latency disk access to audio-video data content from the centralized storage farm eliminating the need to maintain local storage in set-top boxes 220. Since video data content is never stored at an end-user device, piracy issues are significantly reduced.

By incorporating a Narad network interface 226 into set-top boxes 220, consumer entertainment services such as VoD and PVR can be offered from centralized iSCSI gateways 240, without requiring local storage on the set top box 220. This infrastructure can also be seamlessly leveraged for future SAN driven services such as distributing trial versions of software, video game rentals and others.

The Narad network 200 provides a next-generation broadband network architecture called Virtual Fiber™, to support 100 Mbps/1 Gbps Ethernet services over an existing HFC infrastructure. By deploying Ethernet switching elements with integrated high speed modems at critical junction points, today's tree-and-branch cable network topology is augmented with a symmetric, full duplex, data channel that provides orders of magnitude higher bandwidth than is currently available. With built in multi-service QoS capabilities, this next-generation HFC network becomes fully capable of enabling a wide range of broadband services, including VoD and PVR services. The Narad network 200 has a unique “Service Mediation” model that enables network elements to interact with an admission control server and reserve bandwidth along all switched paths. The admission control server maintains a dynamic database of all bandwidth commitments within the Narad network 200. Bandwidth can be allocated on a wide array of parameters such as Layer2/Layer3 addresses, IP source and destination ports and other higher layer identifiers.

The following quality of service classes are supported in the Narad network 200:

Constant Bit Rate Real-Time Services (“CBR-RT”): This class is intended to support real time services that have very stringent delay requirements. Examples include Voice over IP, Storage Area Networking, etc.

Variable Bit Rate Real-Time Services (“VBR-RT”): This class is intended to support the large variety of constant and variable rate bearer services that have a relatively less stringent delay requirement. Examples include IP streaming, etc.

Variable Bit Rate Non-Real-Time (“VBR-nRT”) Services with throughput Guarantees: This QoS class is intended to support VBR services with loose delay requirements, but with throughput guarantees. Examples include corporate service level agreements (“SLA”), overnight data backups, etc.

Unspecified Bit Rate (“UBR”) Services: This QoS class is intended to support UBR services which have no explicit delay or throughput requirements.

This class is typically used for web-surfing, email, etc. Each class can be further fine tuned with parameters such as maximum permitted latency, maximum burst rate, etc.

The entire process of deploying and managing broadband services can be automated through the use of advanced network management and service delivery back-office systems. High levels of network reliability are maintained by making the network elements remotely manageable and self-configurable. By radically compressing service deployment and provisioning intervals cable companies can accelerate the process of new revenue generation. Customers get the benefit of being able to order services on demand from a broadband services portal without waiting for long service turn-up intervals and without worrying about bandwidth constraints. Flow-through provisioning and activation of back-office billing and customer care systems are accomplished through a robust directory based service delivery platform. These features provide additional benefits to customer of video on demand and personal video recorder services.

In conventional storage systems, storage media such as disks and tapes are locally attached to a server. The server accesses storage devices via a PCI SCSI adapter using the SCSI protocol. SCSI is a point-to-point storage access protocol that works over short distances. The limitations of SCSI have led to the development of storage area networking. SAN allows servers to access raw storage over a high-speed network such as Fibre Channel or Gigabit Ethernet. With a SAN infrastructure, storage can be centralized, consolidated and shared among multiple distributed servers. From the server's perspective, SCSI is still used to access the storage devices. However, in SAN environments, SCSI has been adapted to run over a network as opposed to simply in a point-to-point configuration. Until recently, due to the limited bandwidth of IP and Ethernet networks, Fibre Channel has been the preferred networking approach for building SANs. With the advent of Gigabit Ethernet; the focus is shifting towards running SCSI over IP (iSCSI) and Ethernet networks. The storage over IP working group in the IETF has defined a series of protocols for creating SAN solutions over IP and Ethernet networks. With such a IP based SAN infrastructure, MSOs can centralize storage at the metro services delivery center and use it to offer a variety of streaming media services.

Storage networking protocols face some hurdles today, including the quality of the underlying IP network. The Narad network 200 provides an ideal platform to build a SAN infrastructure. In addition to being a high-capacity network, all network elements have been designed from ground-up to support an array of Quality of Service features. These QoS features can support the most stringent jitter and delay requirements imposed by SAN protocols such as FC/IP, iSCSI, and others. On Narad network 200 iSCSI is supported by the QoS class 'Constant Bit Rate-Real Time Services'. Using this QoS class an 8× DVD drive is perfectly supported by a CBR-RT service, provisioned at the rate of 9.6 Mbps, thus providing a basis for video on demand services. The superior managed bandwidth offered by Narad network 200 can easily deliver DVD quality video with Dolby Digital 6-channel sound.

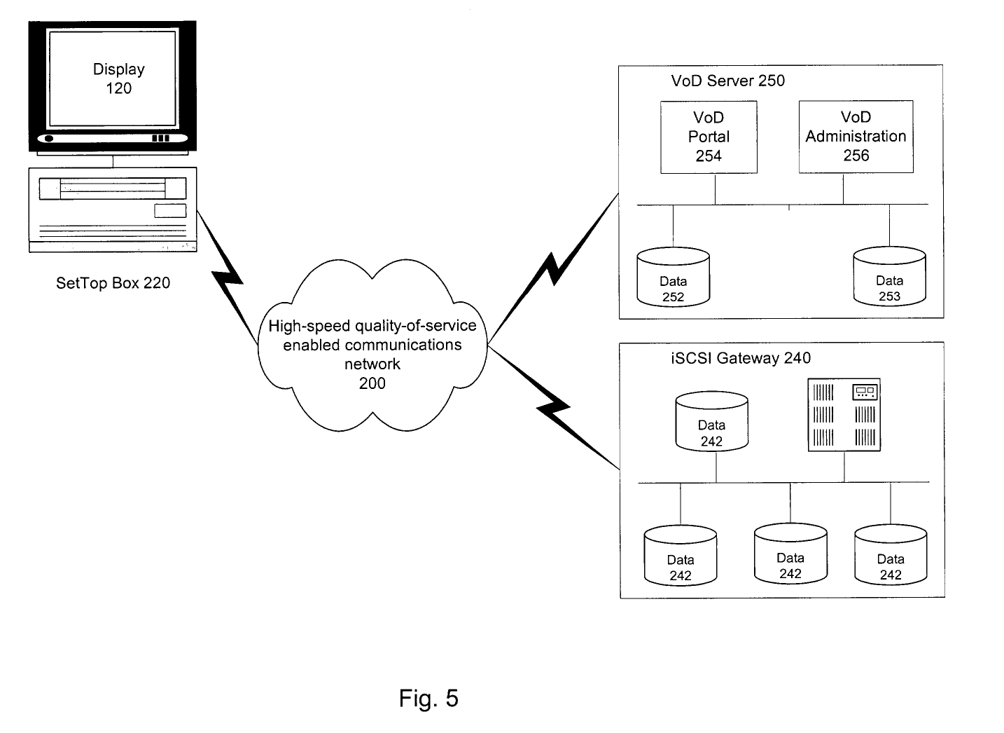

FIG. 5 is an illustration of a video on demand service provided using a virtual storage adapter. As described above, the Narad network 200 can be used for delivering consumer entertainment services. The Narad network 200's PHY and MAC layer technologies, its bandwidth allocation and QoS management software, and iSCSI software are embedded in the set top box 220 (residential gateway) through iSCSI virtual storage adapter 222. The set-top box 220 can also support other home networking solutions for voice and data in addition to audio/video services. The present invention retains all benefits of a hard-disk enabled set top box while eliminating its disadvantages.

Our embodiment for providing video on demand combines the power and flexibility of an intelligent set-top box 220 with a iSCSI storage area network. As opposed to the conventional, mostly one-way, streaming technologies, the present invention leverages the feature rich and interactive audio/video playback mechanism of Digital Versatile Disks. DVDs have taken watching movies to a new level with interactive content in addition to high-quality audio and video.

An embodiment of the present invention provides video on demand by using existing an DVD-capable set top box and turning it into a full-fledged DVD jukebox without the need for DVD hardware (see FIG. 4b). The DVD hardware is replaced with an iSCSI virtual storage adapter 222. The iSCSI virtual storage adapter 222 includes a data storage device emulation unit 224 that emulates a hardware SCSI adapter. The “virtual DVD” is now accessed from a virtual DVD drive residing on a remote Storage Area Network (e.g., iSCSI gateway 240) accessed through the iSCSI protocol using network interface 226. The DVD playback firmware on the set top box handles the virtual DVD drive as if it was locally connected with a SCSI adapter.

Upon startup, the iSCSI virtual storage adapter 222 communicates with the iSCSI gateway 240 and requests a list of SCSI devices. This list of devices is determined entirely by iSCSI gateway 240, on a per-user basis. By dynamically interacting with a server (e.g., VoD server 250) to access a subscriber data 253, the iSCSI gateway 240 transparently augments the set-top box 220 with a virtual DVD player or a virtual DVD jukebox. A customer can simultaneously rent multiple DVDs via such a virtual DVD jukebox. The rented DVDs disappear from the devices list once the rental agreement expires.

In one embodiment a virtual DVD player is provided using the video on demand service of the present invention. Data content 242 (e.g., new movies) are added to the list of movies available for selection stored as part of data 252 using a VoD administration 256 process. Customers select data content 242 for viewing using VoD portal 254 which displays the selection list stored as part of data 252.

VoD administration 256 provides a process that allows an operator to add new data 242 content and store a record of the newly added data content as a data 253 record in an administration database. The record can track information about the new data content, including title, rental price, duration, rating, genre, etc. When the data 242 content (e.g., a DVD) is loaded into the iSCSI gateway 240 a new movie record can also be generated that contains a data 242 content identifier (e.g., movie identifier), iSCSI gateway 240 address, data 242 content size, number of tracks, etc. The data 242 content can then be displayed on VoD portal 254 for selection by customers.

The customer visits VoD portal 254 to browse available data 242 content (e.g., movies, audio recording, other video recording, etc.). The custom can then rent access to specific data 242 content the VoD portal 254. VoD portal 254 interacts with the VoD administration 256 process to access customer specific information and the customer specific information is updated to reflect the transaction (i.e., renting the movie). The VoD administration 256 process handles all billing activities.

Once the customer has selected and “rented” the desired data 242 content they can power on the set top box 220. The DVD player firmware/software in the set top box 220 probes its hardware to identify physical devices. The iSCSI virtual storage adapter 222 sends a SCSI inquiry request to iSCSI gateway 240. iSCSI gateway 240 interacts with the customer specific information maintained by VoD administration 256 and constructs a reply that the device is a DVD juke-box (capable of storing multiple DVDs) which contains all the data 242 content (i.e., the DVDs) rented by the customer. The customer then advances the DVD juke-box and selects the data 242 content (e.g., movie) they wish to watch. As the data 242 content is displayed the DVD player in the set top box 220 issues read requests on bus 130 to the virtual storage device (virtual DVD drive). iSCSI virtual storage adapter 222 re-issues the SCSI read requests to the iSCSI gateway 240 in order to provide the data 242 content for display.

The set top box 220, using network interface 226, dynamically interacts with Narad network 200, including a service mediation system to ensure bandwidth availability and display quality.

The present invention also addresses security issues related to data 242 content protection, both by preventing a physical copy of data 242 content from being stored on set top box 220 and by encrypting (e.g., IPSec) the data 242 content. Data 242 content, including movies, travel the Narad network 200 only when being played. Thus, encryption keys can be dynamically exchanged as and when necessary to ensure privacy and prevent copying. Data 242 content is never stored on set top box 220.

The above described video on demand services make full use of the progress made by the DVD industry in the past few years. Movie studios are spending significant amounts of money to add features such as extra footage, video clips, different angles and other options in the making of movies. In the future, DVDs will also contain links to a movie's Web site, including chat-rooms, merchandise store, etc. to create a truly interactive experience. The present invention can be used to present these new interactive experiences.

The present invention is insensitive to the implementation details of various components in the architecture. As noted above, although the Narad network 200 is one preferred embodiment, any high-speed quality-of-service-enabled communication network meeting the bandwidth criteria for displaying DVD-quality video can be used. In other embodiments VoD Server 250 can be combined within iSCSI Gateway 240 to perform the VoD portal 254 and VoD administration 256 functionality.

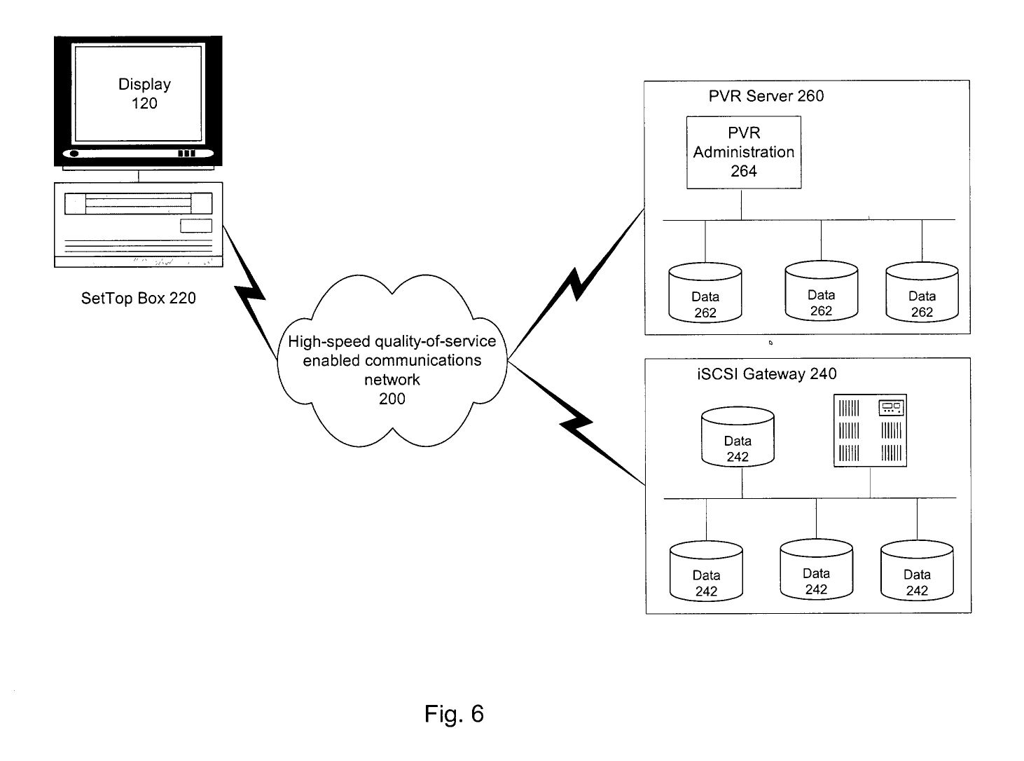

FIG. 6 is an illustration of a personal video recorder service provided using a virtual storage adapter. The iSCSI virtual storage adapter within set top box 220 provides a PVR device that makes remote storage on iSCSI gateway 240 appear as if connected via a local SCSI adapter. The operating system and other software running on the set top box providing the PVR device (e.g., TiVo runs Linux, which has supported SCSI devices since its infancy) requires little to no modification. Similar to the virtual DVD and video on demand service, the iSCSI gateway 240 dynamically determines the disk space allocated to every customer by way of a PVR administration 264 process. A service provider can create multi-tiered services that offer customers virtual hard disks of varying sizes.

In one embodiment the present invention provides capabilities offered by the iSCSI gateway 240 to a network administrator. The iSCSI gateway 240 dynamically interacts with a subscriber database managed by PVR administration 264 to support features such as: program expiration—a recorded program will automatically disappear after a specified duration, (b) capacity on demand allowing for ad hoc storage requests, (c) consolidated recording—even though multiple subscribers may request recording of a popular television show, a single device can perform the recording and then be shared among multiple customers, (d) community VCR—a customer can be allowed to browse through popular programs recorded by other subscribers in a specified community. Thus by consolidating all storage into a high-capacity iSCSI gateway 240 at their data center, a cable operator can offer limitless personal recording capabilities to its customers. In other embodiments PVR Server 260 can be combined within iSCSI Gateway 240 to perform the PVR administration 264 functionality.

While this invention has been particularly shown and described with references to preferred embodiments thereof, it will be understood by those skilled in the art that various changes in form and details may be made therein without departing from the scope of the invention encompassed by the appended claims.

In particular, data as used in this application refers to any content accessible from the virtual devices. The content can be audio, video or any combination of audio and video, as well as text or other types of data.

What is claimed is:

1. A virtual storage adapter providing networked data storage to a data processing device for delivering consumer entertainment services using virtual devices accessed over a high-speed quality-of-service-enabled communications network, comprising:
a data storage device emulation unit emulating the functionality of a data storage device; and
a network interface comprising an iSCSI compatible interface connecting the data storage device emulation unit to an iSCSI storage gateway on the quality of service enabled communications network.

2. The virtual storage adapter of claim 1 wherein the high-speed quality-of-service-enabled communications network provides at least a Constant Bit Rate Real-Time Services level of quality-of-service.

3. The virtual storage adapter of claim 1 wherein the high-speed quality-of-service-enabled communications network is a hybrid-fiber/cable network.

4. The virtual storage adapter of claim 1 wherein the data storage device emulation unit emulates a digital versatile disk (DVD) drive of a DVD player.

5. The virtual storage adapter of claim 1 wherein the data storage device emulation unit emulates a compact disk (CD) drive of a CD player.

6. A system for delivering consumer entertainment services using virtual devices, comprising:
a high-speed quality-of-service-enabled communications network;
a set top box comprising:
a data storage device emulation unit emulating the functionality of a data storage device; and
a network interface comprising an iSCSI compatible interface connecting the data storage device emulation unit to the high-speed quality-of-service-enabled communications network; and
an iSCSI storage gateway connected to the high-speed quality-of-service-enabled communications network.

7. The system of claim 6 further comprising a video on demand server, the video on demand server comprising:
a video on demand portal providing selection of data for a specific user; and
a video on demand administration unit providing data billing and data access expiration management.

8. The system of claim 7 wherein the video on demand portal provides a listing feature to enumerate the currently available data.

9. The system of claim 7 wherein the data access expiration management includes an automatic data access expiration feature.

10. The system of claim 6 further comprising a personal video recorder server, the personal video recorder server comprising:
a personal video recorder administration unit.

11. The system of claim 10 wherein the personal video recorder administration unit provides a data expiration feature.

12. The system of claim 10 wherein the personal video recorder administration unit provides a capacity on demand feature.

13. The system of claim 10 wherein the personal video recorder administration unit provides a consolidated recording feature

14. The system of claim 10 wherein the personal video recorder administration unit provides a community recording feature.

15. A virtual storage adapter providing networked data storage to a data processing device for delivering consumer entertainment services using virtual devices accessed over a high-speed quality-of-service-enabled communications network, comprising:
means for data storage device emulation; and
means for networking an iSCSI compatible interface to connect the data storage device emulation unit to an iSCSI storage gateway on the quality of service enabled communications network.
